(19) United States
(12) Patent Application Publication
(10) Pub. No.: US 2007/0206035 A1
(43) Pub. Date: Sep. 6, 2007

(54) Information Terminal with Return Tray

(75) Inventors: Gert Fuhrmann, Paderborn (DE); Alfons Braeutigam, Paderborn (DE); Heinz Schulte, Paderborn (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 10/593,963

(22) PCT Filed: May 4, 2005
(86) PCT No.: PCT/DE05/00821

§ 371 Date: Sep. 22, 2006

(30) Foreign Application Priority Data
May 7, 2004 (DE) 20-2004-007-545.8

(51) Int. Cl. B41J 3/00; B41J 29/32

(52) U.S. Cl. 347/2; 347/171

(57) ABSTRACT

The invention relates to an information terminal which has at least a basic housing, a display screen, an input apparatus such as a keyboard and/or a card reader, and an output apparatus for outputting documents. Documents which are not picked up by the user are deposited in a return tray. In order to render the documents illegible before depositing them in the return tray, provision is made for the documents to be completely or partially blacked out or to be shredded. A printing device such as an ink-jet printer is advantageously used for the purpose of blacking out the documents. If the documents are printed on thermal paper, a thermal printing line can also be used. A document shredder may be used for shredding the documents.

The invention relates to an information terminal which has at least a basic housing, a display screen, an input apparatus such as a keyboard and/or a card reader, and an output apparatus for outputting documents.

Information terminals of this generic type are known in a wide variety of embodiments and are employed and used in banks, offices, public authorities and museums, but also in industrial service and production areas. The terminal often has a card reader which is in the form of a magnetic card reader or a chip card reader. In these cases, the terminal user inserts his magnetic or chip card, which contains his personal data, and can then call up his personal information on the device, for example his balance on a statement printer. Furthermore, a keyboard may be provided for entering information. The terminal is also provided with a printer so that the data which is called up can be printed on paper. The document is supplied to the user who generally takes it. However, should the user fail to remove the documents from the output apparatus within a specific time interval, said documents are retracted and deposited in a return tray. The documents are later removed from the return tray by service personnel. However, if these documents contain personal data which should not be seen by third parties, this represents a possible security gap.

The object of the invention is therefore to close this security gap.

According to the invention, this object is achieved by the documents being rendered illegible before being deposited in the return tray. Provision is particularly made for the documents to be completely or partially blacked out or to be shredded. A printing device such as an ink-jet printer is advantageously used for the purpose of blacking out the documents. If the documents are printed on thermal paper, a thermal printing line can be used. A document shredder can be used to shred the documents.

Further details and advantages of the invention can be found in the following description and in the drawing in which one exemplary embodiment of the invention is described in greater detail.

### IN THE DRAWING

FIG. 1 shows a perspective illustration of an information terminal according to the invention; and

FIG. 2 shows a schematic view of a printing unit.

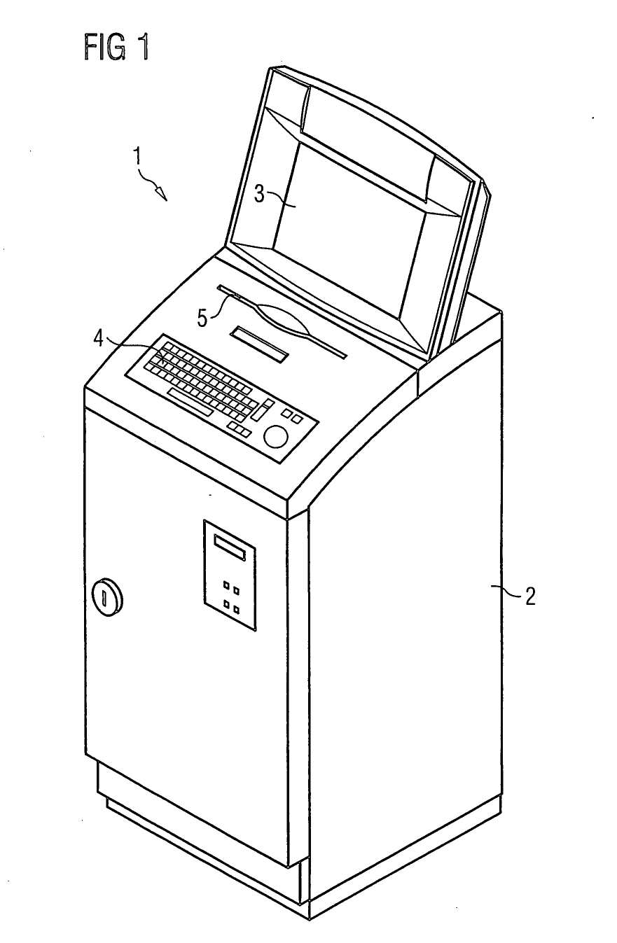

FIG. 1 illustrates an information terminal 1 which in this case may be a statement printer or a device for calling up and processing personal data, for example. Information terminals of this type are used in industry in production facilities, for example to process holiday requests. The information terminal 1 has a basic housing 2, a display screen 3, an input apparatus 4 in the form of a keyboard and/or a card reader (not illustrated here), and an output apparatus 5 for outputting documents. The basic housing 2 contains a computer (not illustrated here) for processing data and actuating the individual components, and a printing unit 6 for printing documents, and a container for the paper supply.

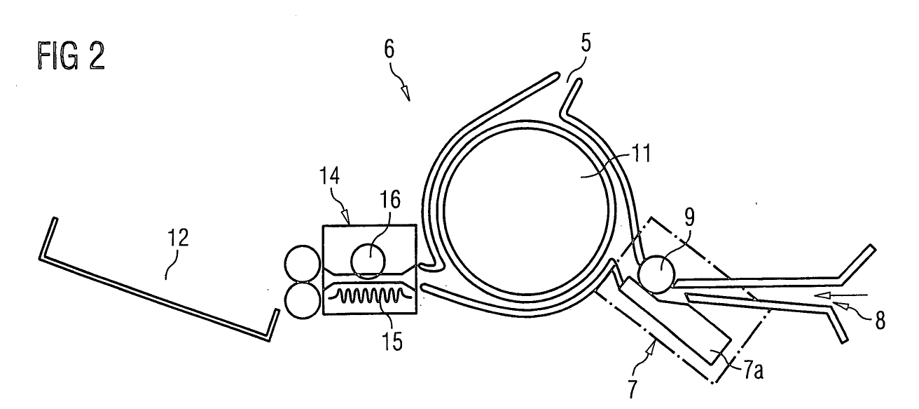

FIG. 2 illustrates the individual components of the printing unit 6 in greater detail. The printing unit 6 comprises a printing station 7, with the exemplary embodiment illustrated here being a thermal printing line 7a for printing thermal paper. Since a thermal printing line is distinguished by an extremely long service life, it is not necessary to replace used ink ribbons, as is the case for a dot matrix printer, with the result that subsequent servicing work on the printing station can be dispensed with, and this is advantageous in the area of self-service in particular. However, a dot matrix printer, an ink-jet printer or a laser printer may be used within the scope of the invention.

The paper to be printed is fed to a document feed 8 of the printing station 7. This document feed may be a dual-action document feed which allows different paper formats or preprinted documents, which are provided with a colored logo for example, to be fed. Therefore, first a colored cover sheet and then a conventional sheet of white paper can be printed, for example. The paper may in each case be individual sheets of paper or an endless paper web which is cut to the desired format in the printing unit. A transporting roller 9 is used to transport the paper and presses the paper against the thermal printing line 7a. In this case, the transporting roller 9 is therefore simultaneously used as a print backing support. However, other rollers and transporting rolls can be used within the scope of the invention. After the paper has been printed, it is passed on to the output apparatus 5. However, a plurality of documents is advantageously output in the form of a bundle. A collection drum 11, for example, is provided in order to form the bundles.

If the supplied documents are not removed, they are withdrawn from the output apparatus 5 again after a specific time interval and transported to a return tray 12 which is regularly emptied by service personnel. According to the invention, a module 14 which renders the withdrawn document unreadable is arranged upstream of the return tray 12. If this involves a bundle of documents, the module 14 is preferably in the form of a cutting apparatus, for example in the form of a document shredder, which shreds the bundle of documents in such a way that said documents can no longer be read. However, if, as is preferred, only individual sheets are output, the information is advantageously completely or partially blacked out. In this case, the module 14 is preferably in the form of a printing device. The printing device used may be, for example, an ink-jet printer which changes the color of the sheet of paper or the critical information contained in the document with an ink, it also being possible for the ink to be a color other than black.

If thermal paper is used, as in the illustrated exemplary embodiment, a thermal printing device can be used as the module 14 to black out the paper, said thermal printing device being a thermal printing line 15 or else a fixing station, as used in laser printers, for example. In this case, it is also feasible for the pixels to not all be activated simultaneously in the case of a thermal printing line, but instead for only some of the pixels to be activated, so that the document is only partially blacked out; but this is not sufficient to render the document illegible. If a bundle of thermal paper is to be blacked out by means of a thermal printing station, the bundle has to be separated by means of a separating apparatus upstream of the module 14, so that single sheets can in each case be fed to the thermal printing station 15. However, when there are two or three documents, it is also possible to simultaneously black out both/all three documents by means of supplying more power to the thermal line. It goes without saying that a bundle of documents is also separated when the module 14 used is an ink-jet printer.

Since some of the withdrawn documents do not contain any critical data, it is not necessary to black out or shred these documents. Provision is therefore advantageously made for the module 14 to be actuated only if the documents contain sensitive data. Therefore, the information is respectively identified in a corresponding manner, so that activation of the module 14 can be controlled by means of application software as a function of the contents of the information. For a thermal printing line for example, this means that the back-pressure roller 16 for pressing the paper against the thermal printing line 15 is not actuated and the pixels of the printing line 15 are not supplied with power. A gap therefore remains between the transporting roller 16 and the thermal printing line 15, and the paper can pass through said gap.

Overall, the invention therefore closes the security gap for withdrawn documents which contain personal or other sensitive data.

1. An information terminal which has at least a basic housing a display screen, an input apparatus, a printing unit for printing documents, an output apparatus for outputting documents, and a return tray for storing documents which are not removed from the output apparatus, characterized in that the return tray has an associated module for rendering illegible the information which is printed on the withdrawn documents.

2. The information terminal as claimed in claim 1, characterized in that the module is in the form of a shredding apparatus.

3. The information terminal as claimed in claim 1, characterized in that the module is in the form of a printing device for completely or partially blacking out the documents.

4. The information terminal as claimed in claim 3, characterized in that the printing device used is an ink-jet printer, it also being possible to use colored ink.

5. The information terminal as claimed in claim 3, characterized in that the printing device used is a thermal printing line.

6. The information terminal as claimed in claim 3, characterized in that the thermal printing device used is a fixing station.

7. The information terminal as claimed in claim 1, characterized in that a separating apparatus is provided for separating a bundle of documents.

8. The information terminal as claimed in claim 1, characterized in that the module is actuated and activated only when the documents contain sensitive data.

9. A printing unit for printing and supplying documents, having at least one document feed means, one or more transporting rollers, at least one printing station, an output apparatus, and a return tray, for storing documents which are not removed from the output apparatus, characterized in that the return tray has an associated module for rendering illegible the information which is printed on the withdrawn documents.

10. The printing unit as claimed in claim 8, characterized in that the module is in the form of a shredding apparatus.

11. The printing unit as claimed in claim 8, characterized in that the module is in the form of a printing device for completely or partially blacking out the documents.

12. The printing unit as claimed in claim 10, characterized in that the printing device used is an ink-jet printer, it also being possible to use colored ink.

13. The printing unit as claimed in claim 10, characterized in that the printing device used is a thermal printing line.

14. The printing unit as claimed in claim 10, characterized in that the thermal printing device used is a fixing station.

15. The printing unit as claimed in claim 8, characterized in that a collection drum (11) is provided for forming a bundle of documents.

16. The printing unit as claimed in claim 8, characterized in that a separating apparatus is provided for separating a bundle of documents.
